(19) United States
(12) Patent Application Publication
(10) Pub. No.: US 2006/0029446 A1
(43) Pub. Date: Feb. 9, 2006

(54) Sheet feeder capable of removing dust

(75) Inventor: Devon Shyu, Kuei Jen Hsiang (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/189,766

(22) Filed: Jul. 27, 2005

(30) Foreign Application Priority Data
Aug. 9, 2004 (TW) 093123847

(51) Int. Cl. G03G 15/00

(52) U.S. Cl. 399/390

(57) ABSTRACT

A sheet feeder capable of removing dust includes a sheet-feeding roller, a dust collecting box and a brush. The sheet-feeding roller transports a sheet along a sheet passageway. The dust collecting box is disposed at a side of the sheet-feeding roller. The dust collecting box has an adhesive layer for collecting and retaining paper flakes and dust coming from the sheet-feeding roller so as to prevent the paper flakes and the dust from being blown back to the sheet passageway. The brush in contact with the sheet-feeding roller brushes the paper flakes and the dust away from the sheet-feeding roller and into the dust collecting box.

### BACKGROUND OF THE INVENTION

1. Field of the Invention

The invention relates to a sheet feeder capable of removing dust, and more particular to a sheet feeder having an adhesive layer for retaining paper flakes and dust so as to achieve the dust-removing effect with a low cost, wherein the sheet feeder of the invention is adapted to document processing devices, such as scanners, copiers, printers and multi-function peripherals.

2. Description of the Related Art

Conventionally, most automatic document feeders are not designed to remove the dust from rollers. In some automatic document feeders with the dust-collecting function, only one dust collecting box is used to collect the paper flakes and the dust. In this case, however, if the rotating speed of the roller is increased, the paper flakes and the dust collected in the dust collecting box tend to be blown or sucked back to the sheet passageway due to the whirling air-flow. Thus, the scanning quality or the printing quality tends to be influenced. The influence tends to occur easily as the sheet-feeding speed is getting higher and higher. Alternatively, the paper flakes and the dust in the dust collecting box tend to be moved back to the sheet passageway when the automatic document feeder is being carried, and the scanning or printing quality is thus influenced.

Taiwan patent publication number 563627 discloses a sheet feeder with the dust-removing function. The sheet feeder has a blowing mechanism and a sucking mechanism for blowing away and sucking the paper flakes or the dust of the sheet. Usually, there may be some paper flakes and dust remained on the sheet after the sheet is cleaned by the blowing and sucking mechanisms, and the paper flakes and the dust tend to cling to the roller after the sheet contacts the roller. So, this art disclosed cannot completely remove the paper flakes or the dust from the roller, and the influence of the paper flakes or the dust still exists. In addition, this art needs large blowing and sucking mechanisms and an air-filtering device, and is not suitable for the small automatic document feeder.

U.S. Pat. No. 6,708,009 discloses a printing device with the dust-removing function. The printing device also collects the dust using a dust collecting box, and a sponge is used to scrape the paper flakes and the dust from the roller. However, the paper flakes and the dust are only isolated from the sheet passageway by the gravity force. So, the size of the dust collecting box has to be enlarged in order to prevent the air-flow, which is produced as the roller is rotating at the high speed, from blowing the paper flakes and the dust back to the sheet passageway. Thus, this sheet feeder is not suitable for the miniaturized scanning device or printing device.

### SUMMARY OF THE INVENTION

It is therefore an object of the invention to provide a sheet feeder capable of removing dust using an adhesive layer to retain paper flakes and dust so as to achieve the dust-removing effect with a low cost.

To achieve the above-mentioned object, the invention provides a sheet feeder including a sheet-feeding roller, a dust collecting box and a brush. The sheet-feeding roller transports a sheet along a sheet passageway. The dust collecting box is disposed at a side of the sheet-feeding roller and has an adhesive layer for collecting and retaining paper flakes and dust so as to prevent the paper flakes and the dust from being blown back to the sheet passageway. The brush, which is in contact with the sheet-feeding roller, brushes the paper flakes and the dust away from the sheet-feeding roller and into the dust collecting box.

The dust collecting box may have a concave portion for storing additional paper flakes and dust so as to increase the dust-collecting capacity.

### BRIEF DESCRIPTION OF THE DRAWINGS

FIG. 1 shows a sheet feeder capable of removing dust according to a first embodiment of the invention.

FIG. 2 shows a sheet feeder capable of removing dust according to a second embodiment of the invention.

### DETAILED DESCRIPTION OF THE INVENTION

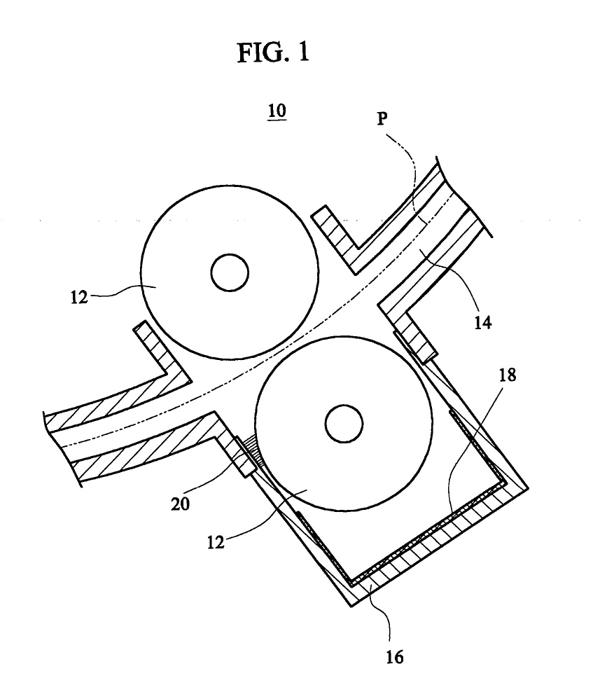

FIG. 1 shows a sheet feeder capable of removing dust according to a first embodiment of the invention. Referring to FIG. 1, the sheet feeder 10 of this embodiment includes two sheet-feeding rollers 12 and a dust collecting box 16. The sheet-feeding rollers 12 transport a sheet P along a sheet passageway 14. Alternatively, only one sheet-feeding roller 12 in conjunction with a caterpillar or other members may be used to transport the sheet. The dust collecting box 16 is disposed at a side of the sheet-feeding roller 12 and has an adhesive layer 18 for collecting and retaining the paper flakes and the dust. Thus, it is possible to prevent the paper flakes and the dust from being blown back to the sheet passageway 14 by the air-flow, which is produced as the sheet-feeding roller 12 is rotating at a high speed. Such a design can provide a relatively stable scanning or printing effect in the scanning or printing product with the operating speed which is getting higher and higher from day to day. It is to be noted that the dust collecting box 16 can be disposed under or above the sheet-feeding roller 12, or on a left side or a right side of the sheet-feeding roller 12.

In order to remove the paper flakes and the dust from the sheet-feeding roller 12 reliably, an additional brush 20, which is usually the lambswool felt, may be attached to the sheet feeder to contact the sheet-feeding roller 12 and brush the paper flakes and the dust away from the sheet-feeding roller 12 and into the dust collecting box 16. The adhesive layer 18, which is a double-sided adhesive tape or is composed of glue, retains the paper flakes and the dust.

According to the above-mentioned design, it is possible to provide a good dust-removing effect without greatly increasing the cost.

In another embodiment, the dust collecting box 16 may be a removable dust collecting box such that a user, who is not a maintenance man, can easily disassemble the dust collecting box 16 and clean the paper flakes and the dust, or replace the double-sided adhesive tape or glue with a new one, or even replace the dust collecting box 16 with a new one.

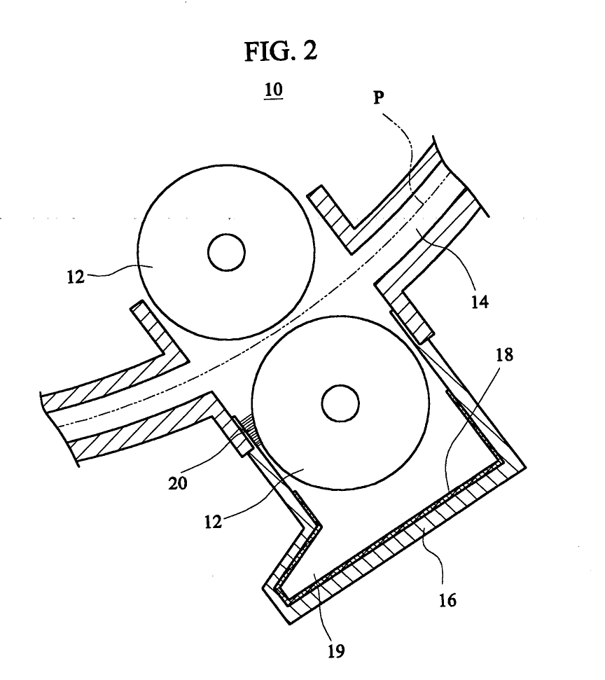

FIG. 2 shows a sheet feeder capable of removing dust according to a second embodiment of the invention. As shown in FIG. 2, this embodiment is similar to the first embodiment except that the dust collecting box 16 has a concave portion 19 for storing additional paper flakes and dust. Thus, after the adhesive layer 18 has been completely covered by the paper flakes and the dust, the additional paper flakes and dust can slide down to the concave portion 19. Typically, the capacity of the dust collecting box 16 may be designed such that the paper flakes and the dust cannot overflow during the lifetime of the scanner or printer. Alternatively, the dust collecting box 16 may be designed such that the user can replace it with a new one conveniently.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A sheet feeder, comprising:
a sheet-feeding roller for transporting a sheet along a sheet passageway; and
a dust collecting box, which is disposed at a side of the sheet-feeding roller and has an adhesive layer for collecting and retaining paper flakes and dust so as to prevent the paper flakes and the dust from being blown back to the sheet passageway.

2. The sheet feeder according to claim 1, further comprising:
a brush, which is in contact with the sheet-feeding roller, for brushing the paper flakes and the dust away from the sheet-feeding roller and into the dust collecting box.

3. The sheet feeder according to claim 1, wherein the adhesive layer is a double-sided adhesive tape.

4. The sheet feeder according to claim 1, wherein the adhesive layer is composed of glue.

5. The sheet feeder according to claim 1, wherein the dust collecting box has a concave portion for storing additional paper flakes and dust.

6. The sheet feeder according to claim 1 being applied to a scanner.

7. The sheet feeder according to claim 1 being applied to a printer.

8. The sheet feeder according to claim 1, wherein the dust collecting box is disposed under the sheet-feeding roller.

9. The sheet feeder according to claim 1, wherein the dust collecting box is disposed above the sheet-feeding roller.

10. The sheet feeder according to claim 1, wherein the dust collecting box is a removable dust collecting box.
